(19) United States
(12) Patent Application Publication
(10) Pub. No.: US 2018/0213285 A1
(43) Pub. Date: Jul. 26, 2018

(54) DISPLAY DEVICE

(71) Applicants: BOE TECHNOLOGY GROUP CO., LTD., Beijing (CN); K-Tronics (Suzhou) Technology Co., Ltd., Suzhou. Jiangsu (CN)

(72) Inventors: Tian YAN, Beijing (CN); Fang XU, Beijing (CN)

(21) Appl. No.: 15/544,918

(22) PCT Filed: Jan. 9, 2017
(86) PCT No.: PCT/CN2017/070597

§ 371 Date: Jul. 20, 2017

(30) Foreign Application Priority Data
Apr. 28, 2016 (CN) 201610274800.1

(51) Int. Cl. H04N 21/472; H04N 21/422; G10L 15/22; G06F 3/0482

(52) U.S. Cl. CPC H04N 21/472; G06F 3/0482; G10L 15/22; H04N 21/422

(57) ABSTRACT

The present disclosure provides a display device having an image processor; a voice instruction detector; and a voice instruction processor. The voice instruction detector detects voice instructions for setting display parameters, and sends the detected voice instruction to the voice instruction processor in the form of voice signal. The voice instruction processor converts the voice instruction in the form of voice signal into a level signal, and sends the level signal to the image processor. The image processor sets the display parameter according to the level signal.

### TECHNICAL FIELD

The present disclosure relates to a display device, in particular, to a display device having a voice controllable on-screen display menu.

### BACKGROUND

Currently, in various commercially available display devices, the setting of the display parameters is usually achieved by operating the On-Screen Display (OSD) menu, that is, the user adjusts the display parameters (such as color, image mode, volume, etc.) of the display device by operating the OSD menu by setting the physical button or touch key at the monitor border, such that the display device may be adjusted to its best operation status.

However, the use of physical buttons or touch keys to control the OSD menu has at least the following defects: 1, the user needs to manually adjust at a close distance to the display device, and the user can not adjust the display in time when the user is not convenient for manual operation (for example, while answering a phone, typing the keyboard, etc.), causing inconvenience to use; and 2, the keys are easy to damage, causing short lifespan.

### SUMMARY

With respect to the above disadvantages in the prior art, the present disclosure provides a display device having a voice controllable OSD menu, which at least in part solves the problems that the current display devices are inconvenience to use when setting or adjusting the display parameters and/or the keys are easy to damage.

According to one aspect, the present disclosure provides a display device including: an image processing module; a voice instruction detecting module; and a voice instruction processing module. The voice instruction detecting module detects voice instructions for setting display parameters, and sends the detected voice instruction to the voice instruction processing module in the form of voice signal. The voice instruction processing module converts the voice instruction in the form of voice signal into a level signal, and sends the level signal to the image processing module. The image processing module sets the display parameter according to the level signal.

According to an embodiment of the present disclosure, the voice instruction may include a type of the display parameter and a value of the display parameter, and a correspondence between the type of the display parameter, the value of the display parameter and the level signal is stored in the voice instruction processing module. The voice instruction processing module may determine the level signal corresponding to the voice instruction according to the type of the display parameter and the value of the display parameter in the voice instruction and the stored correspondence between the type of the display parameter, the value of the display parameter and the level signal.

According to an embodiment of the present disclosure, the voice instruction may include a type of the display parameter and a value of the display parameter, and a correspondence between the type of the display parameter and a range of level signal, and a number of adjusting steps of each type of the display parameter are stored in the voice instruction processing module. The voice instruction processing module may determine the range of level signal corresponding to the display parameter according to the type of the display parameter in the voice instruction and the stored correspondence between the type of the display parameter and a range of level signal, and determine the level signal corresponding to the voice instruction according to the determined range of level signal, the value of the display parameter in the voice instruction and the number of adjusting steps of the display parameter.

According to an embodiment of the present disclosure, the voice instruction detecting module may include a voice sensor.

According to an embodiment of the present disclosure, the voice instruction detecting module may be provided on a frame of the display device.

According to an embodiment of the present disclosure, the display device may further include a mainboard on which the voice instruction processing module and/or the image processing module may be provided.

According to an embodiment of the present disclosure, the display device may further include a display parameter input module including a physical button and/or a touch key configured to convert a press and/or touch operation of a user into the level signal, and send the level signal to the image processing module.

According to an embodiment of the present disclosure, the display parameter input module may be provided on a frame of the display device.

According to the display device of the present disclosure, by using the voice instruction detecting module to detect the voice instruction for setting display parameters, using the voice instruction processing module to convert the voice instruction in the form of voice signal into a level signal, and using the image processing module to set the display parameter according to the level signal, it is possible to control the corresponding operation of the OSD menu of the display device using voice instructions to set display parameters of the display device. Using the display device according to the present disclosure, in the case where the user is far away from the display device or the user's hands are occupied, the user may set the display parameters in a timely and convenient manner when the user needs to set the display parameter. In addition, by using the voice instructions instead of the existing key operation, it is possible to solve the problem that the key may be easy to damage, thus extending the lifespan of the display device.

### BRIEF DESCRIPTION OF THE DRAWINGS

The accompanying drawings are provided for a further understanding of the present disclosure and constitute a part of the specification, and together with the following detailed description, serve to illustrate the present disclosure, but are not to be construed as limiting the present disclosure. In the drawings:

FIG. 1 is a schematic block diagram of the display device having a voice controllable OSD menu according to the present disclosure; and

FIG. 2 is a schematic general structural diagram of the display device having a voice controllable OSD menu according to the present disclosure.

### DETAILED DESCRIPTION

Hereinafter, the technical solution of the present disclosure will be described clearly and completely with reference to the accompanying drawings of the present disclosure. It is obvious that the described embodiments illustrate the concept of the present disclosure by way of example only and are not intended to limit the scope of the present disclosure. On the basis of the disclosed embodiments, all other embodiments obtained by those of ordinary skill in the art without creative work fall within the protection scope of the present disclosure.

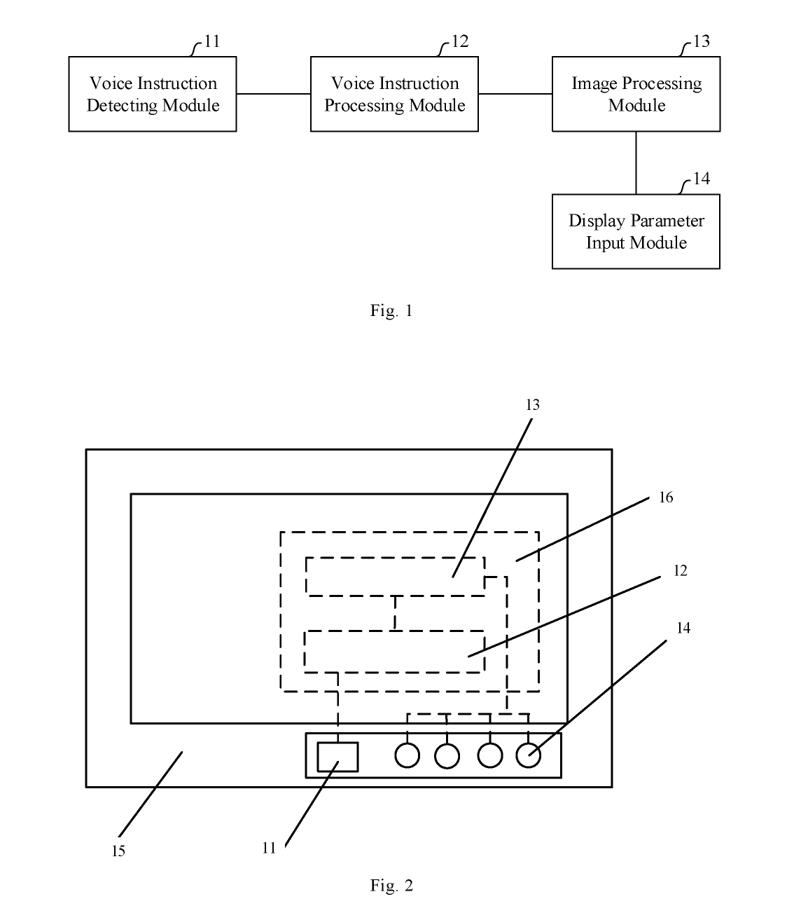

Hereinafter, the technical solutions of the present disclosure will be described in detail with reference to FIGS. 1 and 2.

FIG. 1 is a schematic block diagram of the display device having a voice controllable OSD menu according to the present disclosure, and FIG. 2 is a schematic general structural diagram of the display device having a voice controllable OSD menu according to the present disclosure.

As illustrated in FIG. 1, the present disclosure provides a display device having a voice controllable OSD menu, the display device includes an image processing module 13, a voice instruction detecting module 11 and a voice instruction processing module 12. The voice instruction processing module 12 is connected to the voice instruction detecting module 11 and the image processing module 13, respectively.

The voice instruction detecting module 11 detects the voice instructions for setting display parameters, and sends the detected voice instruction to the voice instruction processing module 12 in the form of voice signal. The voice instruction processing module 12 converts the voice instruction in the form of voice signal into a level signal, and sends the level signal to the image processing module 13. The image processing module 13 sets the display parameter according to the level signal.

By using the voice instruction detecting module 11 to detect the voice instruction for setting display parameters, using the voice instruction module 12 to convert the voice instruction in the form of voice signal into a level signal, and using the image processing module 13 to set the display parameter according to the level signal, it is possible to control the corresponding operation of the OSD menu of the display device using voice instructions to set display parameters of the display device.

According to the embodiment of the present disclosure, the voice instructions may include a type and a value of the display parameter. The type of the display parameter may include (but not limited to) brightness, contrast ratio, grayscale, volume, image mode, and the like. The value range of the value of the display parameter is usually preset by the manufacturer of the display device.

It should be noted that the user may be required to issue the voice instruction according to certain rules. For example, the instruction regarding the type of the display parameter is issued firstly, and then the value of the display parameter of this type is issued, with a certain period of time between the above two.

According to the embodiment of the present disclosure, the voice instruction in the form of voice signal may be converted into a level signal according to at least two schemes. One scheme includes establishing a one-to-one correspondence between each value of each type of display parameter and the level signal, i.e., a correspondence between the type of the display parameter, the value of the display parameter and the level signal. It is possible to obtain the corresponding level signal by looking up the correspondence according to the voice instruction, and the level signal corresponds uniquely to a setting operation of the corresponding display parameter. Please refer to the following table 1.

TABLE 1

| Type of the | Value of the | Level signal |
|---|---|---|
| display parameter | display parameter | (V) |
| Brightness | 0 | 0 |
| Brightness | 1 | 0.01 |
| Brightness | 2 | 0.02 |
| Brightness | . . . | . . . |
| Brightness | 98 | 0.98 |
| Brightness | 99 | 0.99 |
| Brightness | 100 | 0.1 |
| Contrast Ratio | 1 | 0.11 |
| Contrast Ratio | 2 | 0.12 |
| Contrast Ratio | . . . | . . . |
| Contrast Ratio | 50 | 0.5 |
| . . . | . . . | . . . |

The correspondence between the type of the display parameter, the value of the display parameter and the level signal may be stored in the voice instruction processing module 12. It should be appreciated that the correspondence may be stored according to a data structure other than the form of table.

The voice instruction processing module 12 determines the level signal corresponding to the voice instruction according to the type of the display parameter and the value of the display parameter in the voice instruction and the stored correspondence between the type of the display parameter, the value of the display parameter and the level signal.

In other words, the voice processing module 12 acquires the type of the display parameter and the value of the display parameter in the voice instruction, and obtains the corresponding level signal by, for example, looking up the table. For example, the user issues a voice instruction including “Contrast Ratio, 50”, and the voice instruction processing module 12 obtains the level signal of 0.5 V corresponding to the contrast ratio of 50 by looking up the table 1.

According to the embodiment of the present disclosure, the other scheme for converting the voice instruction in the form of voice signal into the level signal includes: assigning a corresponding range of level signal for each type of display parameter. The range of level signal corresponding to each type of display parameter may be continuous or discontinuous, and the level signal corresponding to the value of various types of display parameters may be uniformly distributed over the corresponding range of level signal. For example, with respect to the display parameter of brightness, in the case where the range of level signal corresponding to brightness is 0-1V, and the brightness includes 101 adjusting steps (i.e., 0-100), the difference between adjacent two level signals corresponding to brightness may be 0.01V. For example, the 0^{th} step of brightness corresponds to the level signal of 0V, the 50^{th} step of brightness corresponds to the level signal of 0.5V, and the 100^{th} step of brightness corresponds to the level signal of 1V. Firstly, the correspondence between the type of the display parameter and the range of level signal is determined, then the range of the level signal corresponding to said type of display parameter is determined according to the type of the display parameter in the voice instruction, and then the particular level signal is determined in the determined range of level signal according to the value of the display parameter in the voice instruction. Please refer to the following table 2.

TABLE 2

| Type of the | Range of level signal |
|---|---|
| display parameter | (V) |
| Brightness | 0-1 |
| Contrast Ratio | 1-2 |
| Grayscale | 2-3 |
| Volume | 3-4 |
| Image Mode | 4-5 |
| . . . | . . . |

The correspondence between the type of the display parameter and the range of level signal, as well as the number of adjusting steps of various types of display parameters (not illustrated), may be stored in the voice instruction processing module 12.

The voice instruction processing module 12 determines the range of level signal corresponding to the display parameter according to the type of the display parameter in the voice instruction and the stored correspondence between the type of the display parameter and the range of level signal, and determines the level signal corresponding to the voice instruction according to the determined range of level signal, the value of the display parameter in the voice instruction and the number of adjusting steps of the display parameter.

In other words, the voice instruction processing module 12 acquires the type of the display parameter and the value of the display parameter in the voice instruction, obtains the corresponding range of level signal in the table 2 according to the type of the display parameter, and then determines the level signal corresponding to the value of the display parameter according to the value of the display parameter in the voice instruction and the number of adjusting steps of the display parameter. For example, the user issues a voice instruction including “Contrast Ratio, 50”, and the voice instruction processing module 12 obtains that the type of the display parameter in the voice instruction is the contrast ratio, and the value thereof is 50, obtains the range of level signal corresponding to the contrast ratio of 1-2V and the number of adjusting steps of the contrast ratio of 101 (i.e., 0-100) by looking up the table 2 according to the “contrast ratio”, and then calculates to obtain the level signal corresponding to the voice signal of 1.5 V.

According to the embodiment of the present disclosure, the voice instruction detecting module 11 may include a voice sensor.

Hereinafter, detailed structure of the display device according to the embodiment of the present disclosure will be described in detail with reference to FIG. 2.

As illustrated in FIG. 2, the voice instruction detecting module 11 may be provided on the frame 15 of the display device. As shown in the figure, the voice instruction detecting module 11 is provided on the lower frame of the display device. The voice instruction detecting module 11 may be provided to be facing the user, so as to facilitate the reception and detection of the voice instructions from the user.

The voice instruction processing module 12 and the image processing module 13 may be provided on the mainboard 16 of the display device.

The display device according to the embodiment of the present disclosure may further include a display parameter input module 14, which may include a physical button or a touch key for converting the press/touch operation of the user into a level signal and sending the level signal to the image processing module 12.

The display parameter input module 14 may be provided on the frame 15 of the display device. As shown in FIG. 2, the display parameter input module 14 is provided at the lower frame of the display device.

According to the present embodiment, by simultaneously providing the display parameter input module 14 and the voice instruction detecting module 11 and the voice instruction processing module 12, the display device may simultaneously have the function of setting the display parameter both by manual operation and voice control. The two means for setting the display parameter are provided simultaneously for complement or replacement, thereby improving the reliability of the display device.

It should be appreciated that, the above embodiments are exemplary implementations for illustrating the principle of the present disclosure only, while the present disclosure is not limited thereto. Various modifications and improvements are possible to those of ordinary skill in the art without departing from the spirit and essence of the present disclosure. All these modifications and improvements will also fall into the protection scope of the present disclosure.

1. A display device comprising:
an image processor;
a voice instruction detector; and
a voice instruction processor,
wherein the voice instruction detector detects voice instructions for setting display parameters, and sends the detected voice instruction to the voice instruction processor in the form of voice signal,
the voice instruction processor converts the voice instruction in the form of voice signal into a level signal, and sends the level signal to the image processor, and
the image processor sets the display parameter according to the level signal.

2. The display device according to claim 1, wherein:
the voice instruction comprises a type of the display parameter and a value of the display parameter, and a correspondence between the type of the display parameter, the value of the display parameter and the level signal is stored in the voice instruction processor, and
the voice instruction processor determines the level signal corresponding to the voice instruction according to the type of the display parameter and the value of the display parameter in the voice instruction and the stored correspondence between the type of the display parameter, the value of the display parameter and the level signal.

3. The display device according to claim 1, wherein:
the voice instruction comprises a type of the display parameter and a value of the display parameter, and a correspondence between the type of the display parameter and a range of level signal, and a number of adjusting steps of each type of the display parameter are stored in the voice instruction processor, and
the voice instruction processor determines the range of level signal corresponding to the display parameter according to the type of the display parameter in the voice instruction and the stored correspondence between the type of the display parameter and a range of level signal, and determines the level signal corresponding to the voice instruction according to the determined range of level signal, the value of the display parameter in the voice instruction and the number of adjusting steps of the display parameter.

4. The display device according to claim 1, wherein the voice instruction detector comprises a voice sensor.

5. The display device according to claim 4, wherein the voice instruction detector is provided on a frame of the display device.

6. The display device according to claim 1, further comprising a mainboard on which the voice instruction processor is provided.

7. The display device according to claim 1, further comprising a mainboard on which the image processor is provided.

8. The display device according to claim 1, further comprising:
a display parameter input device comprising a physical button and/or a touch key configured to convert a press and/or touch operation of a user into the level signal, and send the level signal to the image processor.

9. The display device according to claim 8, wherein the display parameter input device is provided on a frame of the display device.
